(19) United States
(12) Patent Application Publication
(10) Pub. No.: US 2020/0206079 A1
(43) Pub. Date: Jul. 2, 2020

(54) Platelet oscillation storage box

(71) Applicant: Guocheng Qian, Guangzhou City (CN)

(72) Inventor: Guocheng Qian, Guangzhou City (CN)

(21) Appl. No.: 16/812,406

(22) Filed: Mar. 9, 2020

(30) Foreign Application Priority Data
Nov. 26, 2019 (CN) 2019111761672

(51) Int. Cl. A61J 1/05; B65D 25/02; B01F 11/00

(52) U.S. Cl. CPC A61J 1/05; B01F 11/0005; B65D 25/02

(57) ABSTRACT

The invention discloses a platelet oscillating storage box, which includes a box body. The box body is provided with six circular array and connected rotating cavities. There are five storage blocks in the rotating cavity, and the storage blocks are provided with storage. A cavity, a storage block is fixed on the lower end wall of the storage cavity, and an end of the storage cavity close to the center of the array is provided with a fixed block that is symmetrical up and down, and a movable clamping block is provided between the fixed blocks. The clamping device can be used to clamp the test tube containing the platelets in the storage cavity, and the storage cavity is independent and communicates with the thermostat independently. When taking or storing platelets, the thermostatic conditions in the storage cavity to be placed are blocked. Cut off, reducing energy loss, without destroying the constant temperature environment in other storage chambers, and prolonging the storage time of platelets. Secondly, the sealing device can keep the storage chamber sealed, and the sealing cover and the storage chamber remain locked during the oscillation process. Ensure constant temperature in the storage chamber.

### CROSS-REFERENCES TO RELATED APPLICATIONS

The present application claims priority from Chinese application No. 2019111761672 filed on Sep. 19, 2019 which is hereby incorporated by reference in its entirety.

### TECHNICAL FIELD

The invention relates to the field of medical technology, in particular to a platelet oscillation storage box.

### BACKGROUND OF THE INVENTION

The storage conditions of platelets are continuous shaking at a constant temperature and a short storage time. The existing platelet storage box is provided with a single opening and closing box door, and the platelet test tubes are placed in the internal storage cavity of the box uniformly. When the door of the box is opened, the internal temperature of the box is out of control, and the oscillation stops, causing the storage conditions of other stored platelets to fail to meet the standards, which leads to the clot of the storage liquid, which is unusable and wastes platelets. Second, the existing platelet storage box The test tubes are placed uniformly and the visibility is low. The present invention illustrates a device capable of solving the above problems.

### BRIEF SUMMARY OF THE INVENTION

### Technical Problem

Existing platelet storage boxes have poor sealing and constant temperature conditions, which is likely to cause platelet clumping and waste, and is inconvenient to take or store.

In order to solve the above problems, a platelet oscillation storage box is designed in this example. The platelet oscillation storage box in this example includes a box body, and the box body is provided with six circular array and connected rotating cavities. There are five storage blocks in the cavity, the storage block is provided with a storage cavity, a lower end wall of the storage cavity is fixed with a placing block, and an end of the storage cavity near the center of the array is fixed with a symmetrical upper and lower fixing block. A movable clamping block is provided between the fixed blocks, the clamping block and the center of the fixed block both penetrate up and down and a buffer pad is fixed on the inner end wall thereof, and a test tube storing the platelets is placed on the fixed block The test tube is placed between the holding block and the lower end of the test tube. The holding block is moved toward the center of the array to clamp the test tube. A clamping device, which can drive the clamping block to move horizontally for clamping and loosening of the test tube. A sealing device is provided on the upper side of the storage chamber, and the sealing device includes a rotatable device. Sealing cover and lifting sealing plate, When the sealing cover is set horizontally, the sealing plate extends into the storage cavity to seal it, and a fixing plate is fixed between the upper end surfaces of the storage blocks. A thermostat is installed in the fixing plate, and the storage cavity A communication cavity is provided between the thermostat and the thermostat to maintain constant temperature in the storage cavity. A cutting device is provided on the upper side of the circulation cavity. The cutting device includes a blocking plate that can be moved forward and backward. A break plate can block the flow of the flow chamber. At this time, the operation of the cutting device can provide power for the operation of the sealing device. An oscillating device is provided under the thermostat. The oscillating device includes an oscillating motor and the oscillating device. When the five storage blocks of the motor are connected, the operation of the oscillating motor drives the storage cavity to oscillate, and the test tube oscillates, which is convenient for storing platelets.

Preferably, the lower end surface of the storage block is a toothed structure, a driving groove is provided at the lower end wall of the rotating cavity, a driving gear meshing with the storage block is rotatably provided in the driving groove, and the right end wall of the driving groove is A driving motor is installed, and the driving gear is dynamically connected to the driving motor, so that the driving motor works to drive five of the storage blocks to rotate, so that the storage block to be accessed or placed with platelets rotates to the rotating cavity. Inside right position for operation.

Wherein, the clamping device includes a through groove communicating with the storage cavity, an end of the clamping block near the center of the array extends into the through groove, and a lower end surface of the clamping block is a toothed structure, so A self-locking groove is provided on the lower side of the through groove, and a transmission gear meshing with the clamping block is rotatably provided in the self-locking groove. A turbine is fixed on one end surface of the transmission gear, and the turbine is close to the center of the array. A worm is meshed and connected, a worm shaft is fixed at the center of the worm, a connection groove is provided at the lower side of the self-locking groove, a lower end of the worm shaft extends into the connection groove, and a first bevel gear is fixed. A second bevel gear is meshedly connected to an end of the first bevel gear away from the center of the array. A spline rod is splined at the center of the second bevel gear. A third bevel gear is fixed to the left end of the spline rod. A moving groove is provided on the right side of the connecting groove, and a moving block is slidably arranged in the moving groove. The right end of the spline rod is rotatably connected to the moving block. The upper end surface of the moving block is tooth-shaped and meshed with rotation. Gear, a gear shaft is fixed at the center of the rotating gear Therefore, when the spline lever rotates, the transmission gear is rotated, and then the horizontal movement of the clamping block is controlled. The self-locking structure of the turbine and the worm locks the position of the clamping block, increasing the position of the clamping block. The clamping stability of the test tube is described.

Preferably, an annular cavity is provided in the box body, and a conical toothed ring is provided in the annular cavity for rotation, and the outer periphery of the conical toothed ring can mesh with the third bevel gear, and the conical toothed ring A power gear is meshed with the inner end wall, and a power motor is fixed on the upper end wall of the annular cavity. The power gear is dynamically connected with the power motor, so that the power motor works to drive the conical gear ring to rotate. The holding device works to provide power.

Wherein, the sealing device includes an opening and closing groove that communicates with the upper side of the storage cavity and the outside, the sealing cover is rotatably provided in the opening and closing groove through a flip shaft, and the front end of the flip shaft and the gear rotating shaft pass through A linkage belt is dynamically connected. A handle is fixed on the upper end surface of the sealing cover. A receiving slot with an opening facing downward is provided in the sealing cover. The sealing plate is slidably disposed in the receiving slot. There is a meshing cavity. A connecting bevel gear is provided in the meshing cavity through a screw shaft to rotate. The lower end of the screw shaft extends into the receiving groove and is threadedly connected to the sealing plate. The connecting bevel gear is near one end of the array center. A rotating bevel gear is meshed and connected, a spline shaft is fixed at the center of the rotating bevel gear, a side of the meshing cavity near the center of the array is provided with a thread groove, and the other end of the spline shaft extends into the thread groove. And a device is splined on it, and a fourth bevel gear is rotatably provided at an end of the sealing cover near the center of the array. The center of the fourth bevel gear is splined and is splined to the device. Slot close A lock groove is provided on one side of the thermostat, and the device can be extended into the lock groove to lock the sealing cover.

Preferably, the inner end wall of the spline shaft is thread-shaped, the outer periphery of the device is composed of a spline structure and a threaded structure, the outer periphery of the spline part of the device is splined to the fourth bevel gear, and the device The threaded part is screwed with the thread groove, so that the rotation of the fourth bevel gear drives the device to rotate, the device moves horizontally, locks or unlocks the sealing cover, and the device drives the spline shaft to rotate, The sealing plate can be lifted to seal or open the storage cavity.

Wherein, the cutting device includes a blocking groove communicating with the circulation cavity, the blocking plate is slidably disposed in the blocking groove, and a lower end surface of the blocking plate is a toothed structure, and the blocking plate A transmission cavity is provided on the lower side of the broken groove, and a spur gear meshing with the blocking plate is provided in the transmission cavity for rotation. A fifth bevel gear is fixed at one end of the spur gear away from the thermostat. A symmetrical connecting shaft is provided in the cavity, and a transmission bevel gear is fixed on the connecting shaft. The transmission bevel gear is composed of a bevel gear and a pulley fixed front and rear, and the transmission bevel gear cone near the thermostat side. A gear portion is meshed with the fifth bevel gear, and a sixth bevel gear is meshed with the bevel gear portion of the transmission bevel gear away from the thermostat. The left and right transmission bevel gear pulley portions are connected by a timing belt. In a power connection, a transmission shaft is fixed at the center of the sixth bevel gear, and the transmission axis extends upward and a seventh bevel gear meshing with the fourth bevel gear is fixed, so that when the transmission bevel gear rotates, To drive the blocking plate to move Closed state to control the flow bore, and the seventh bevel gear rotation power the operation of the seal.

Preferably, the storage block is provided with a telescopic groove near the center of the array, and the telescopic groove is slidably provided with a telescopic block whose lower end surface is tooth-shaped and whose rear end is a bevel structure. A telescoping spring is fixed between the telescoping grooves, and a rotating space is communicated with the lower side of the telescoping grooves. A symmetrical rotating shaft is provided for rotation in the rotating space, and a rotating pulley is fixed on the rotating shaft. The rotating pulleys are connected by a rotating belt power. The rear end of the rotating pulley near the center of the array is fixed with a meshing gear that meshes with the telescopic block. The rear end of the rotating shaft on the side far from the center of the array is fixed. It is dynamically connected with the rear end of the connection shaft on the side near the center of the array through a transmission belt, so that the transmission belt rotates when the telescopic block moves horizontally, and then the connection shaft rotates, which is the cutting device. Provide motivation.

Preferably, a groove is provided in the left end wall of the turning cavity on the right side, and when the telescopic groove is opposite to the groove position, the telescopic block can be extended to the position by the elastic force of the telescopic spring. In the groove, the telescopic block moves horizontally.

Wherein, the oscillating device includes an oscillating cavity, the oscillating motor is fixed on the lower end wall of the oscillating cavity, an oscillating shaft is power-mounted on the upper end of the oscillating motor, and an oscillating plate is fixed on the upper end of the oscillating shaft. The five storage blocks are respectively fixedly connected, so that the oscillating motor works, and the storage blocks are oscillated by the oscillating plate.

The beneficial effect of the present invention is that the test tube in which the platelets are stored can be clamped in the storage cavity by the clamping device of the present invention, and the storage cavity is independent and communicates with the thermostat independently. The constant temperature conditions in the storage chamber are blocked, reducing the loss of energy, without destroying the constant temperature environment in other storage chambers, and extending the storage time of platelets. Secondly, the sealing device can keep the storage chamber in a sealed state, and during the oscillation process The sealing cover and the storage chamber are always locked to ensure constant temperature in the storage chamber.

### BRIEF DESCRIPTION OF THE DRAWINGS

For ease of explanation, the present invention is described in detail by the following specific embodiments and the accompanying drawings.

FIG. 1 is a schematic diagram of the overall structure of a platelet storage tank according to the present invention; FIG.

FIG. 2 is an enlarged structural diagram of “A” of FIG. 1; FIG.

FIG. 3 is a schematic structural diagram of the “B-B” direction of FIG. 2;

FIG.

FIG. 4 is an enlarged structural diagram of “C” in FIG. 2; FIG.

FIG. 5 is an enlarged structural diagram of “D” of FIG. 2.

### DETAILED DESCRIPTION OF THE INVENTION

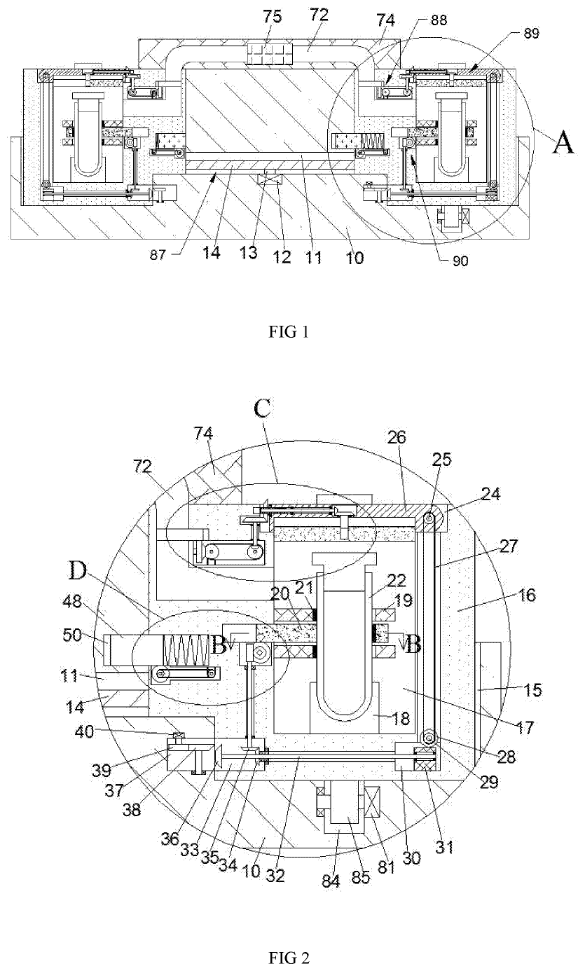

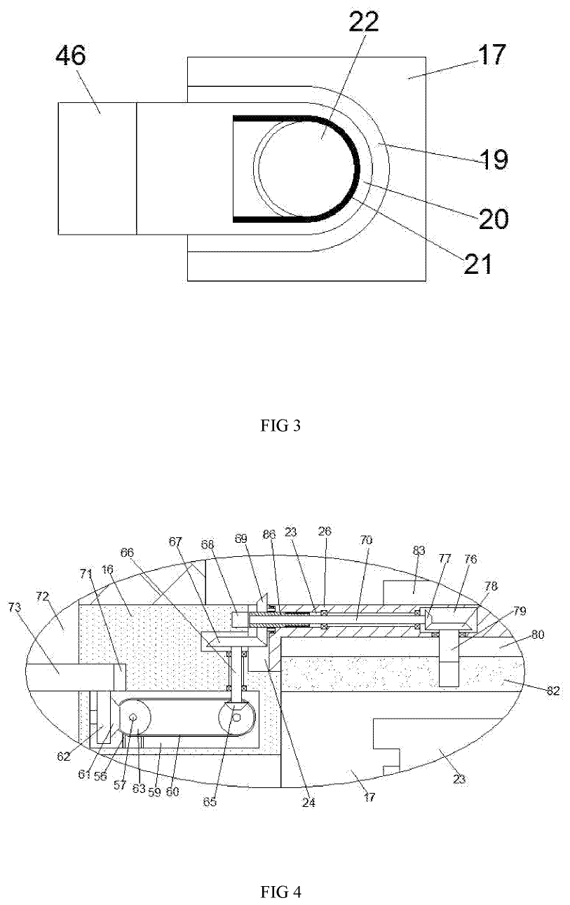

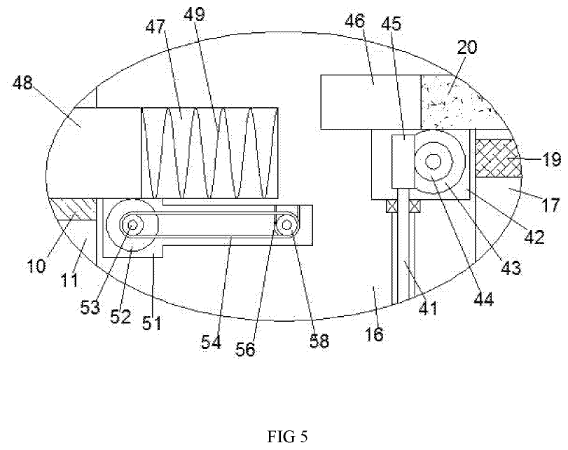

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG. 1 itself.

The present invention relates to a platelet oscillation storage box, which is mainly used for storing platelets. The present invention will be further described below with reference to the accompanying drawings of the present invention:

A platelet oscillation storage box according to the present invention includes a box body 10, which is provided with six circular arrays and connected rotating cavities 15, and five storage blocks 16 in the rotating cavities. A storage cavity 17 is provided in the storage block 16, and a placement block 18 is fixed on the lower end wall of the storage cavity 17. An end of the storage cavity 17 near the center of the array is fixed with a vertically symmetrical fixing block 19. The fixing block 19 A movable clamping block 20 is provided therebetween, and the center of the clamping block 20 and the fixing block 19 penetrates up and down, and a buffer pad 21 is fixed on the inner end wall thereof, and a test tube 22 storing platelets is placed in the center. The lower end of the test tube 22 is placed between the fixing block 19 and the holding block 20 and the test tube 22 is placed in the placing block 18. The holding block 20 is moved toward the center of the array to clamp the test tube 22, and the storage A clamping device 90 is provided on the side of the cavity 17 near the center of the array. The clamping device 90 can move the clamping block 20 horizontally for clamping and releasing the test tube 22, and the storage cavity 17 is provided with a sealing device 89 on the upper side, which includes a rotatable sealing cover 26 and a lifting sealing plate 82 When the sealing cover 26 is set horizontally, the sealing plate 82 extends into the storage cavity 17 to seal it. A fixing plate 74 is fixed between the upper end surfaces of the storage block 16, and the fixing plate 74 is installed therein. A thermostat 75, a communication chamber 72 is provided between the storage chamber 17 and the thermostat 75, so that the storage chamber 17 is kept at a constant temperature, and a cutting device 88 is provided on the upper side of the circulation chamber 72. The cutting device 88 includes a blocking plate 73 that can move forward and backward, and the blocking plate 73 can block the flow of the circulation cavity 72. At this time, the operation of the cutting device 88 can provide power for the operation of the sealing device 89. An oscillating device 87 is provided on the lower side of the thermostat 75. The oscillating device 87 includes an oscillating motor 12, and the five storage blocks 16 of the oscillating motor 12 are connected. Then, the operation of the oscillating motor 12 drives the storage cavity 17 to oscillate. Then, the test tube 22 oscillates to facilitate storage of platelets.

Beneficially, the lower end surface of the storage block 16 is a toothed structure, and a driving groove 84 is provided on the lower end wall of the rotating cavity 15, and a driving gear 85 meshing with the storage block 16 is rotatably provided in the driving groove 84. A drive motor 81 is installed on the right end wall of the drive groove 84, and the drive gear 85 is dynamically connected to the drive motor 81, so that the drive motor 81 works to drive the five storage blocks 16 to rotate, so that platelets to be accessed or placed The storage block 16 is rotated to a right position in the rotation cavity 15 for operation.

According to the embodiment, the clamping device 90 is described in detail below. The clamping device 90 includes a through groove 46 communicating with the storage cavity 17. An end of the clamping block 20 near the center of the array extends to the through groove. 46, and the lower end surface of the clamping block 20 is a toothed structure. A self-locking groove 42 is provided on the lower side of the through groove 46, and a self-locking groove 42 is rotatably provided in the self-locking groove 42 to mesh with the clamping block 20. A transmission gear 43, a turbine 44 is fixed on one end surface of the transmission gear 43, and a worm 45 is meshed with the end of the turbine 44 near the center of the array. A worm shaft 41 is fixed at the center of the worm 45, and the self-locking groove A connecting groove 33 is provided on the lower side of the 42. The lower end of the worm shaft 41 extends into the connecting groove 33 and a first bevel gear 35 is fixed. A second end of the first bevel gear 35 away from the center of the array is meshed with a second gear. Bevel gear 34, a spline rod 32 is splined at the center of the second bevel gear 34, a third bevel gear 36 is fixed at the left end of the spline rod 32, and a moving groove 30 is provided at the right side of the connection groove 33 A moving block 31 is slidably provided in the moving groove 30, and the right end of the spline lever 32 is rotatably connected to the moving block 31. Then, the upper end surface of the moving block 31 is tooth-shaped and meshed with a rotating gear 28, and a gear rotating shaft 29 is fixed at the center of the rotating gear 28, so that the transmission gear 43 is rotated when the spline lever 32 rotates Then, the horizontal movement of the clamping block 20 is controlled. The self-locking structure of the turbine 44 and the worm 45 locks the position of the clamping block 20 and increases the clamping stability of the test tube 22.

Beneficially, an annular cavity 37 is provided in the casing 10, and a conical toothed ring 38 is rotatably provided in the annular cavity 37. The outer periphery of the conical toothed ring 38 can mesh with the third bevel gear 36. A power gear 39 is meshed with the inner end wall of the conical ring gear 38, and a power motor 40 is fixed on the upper end wall of the annular cavity 37. The power gear 39 is dynamically connected to the power motor 40, so that the power motor 40 The work drives the conical gear ring 38 to rotate, and provides power for the work of the clamping device 90.

According to the embodiment, the sealing device 89 is described in detail below. The sealing device 89 includes an opening and closing groove 24 that communicates with the upper side of the storage cavity 17 and the outside. The sealing cover 26 is rotatably provided on the opening through a flip shaft 25. In the coupling groove 24, the front end of the flip shaft 25 and the gear rotation shaft 29 are connected by a linkage belt 27. A handle 83 is fixed on the upper end surface of the sealing cover 26. An accommodation groove 80, the sealing plate 82 is slidably disposed in the accommodation groove 80, an engagement cavity 76 is provided on the upper side of the accommodation groove 80, and a connection bevel gear 78 is provided in the engagement cavity 76 through a screw shaft 79, The lower end of the threaded shaft 79 extends into the receiving groove 80 and is threadedly connected to the sealing plate 82. An end of the connection bevel gear 78 near the center of the array is meshed with a rotating bevel gear 77, and the center of the rotating bevel gear 77 A spline shaft 70 is fixed at the place. A thread groove 23 is provided on a side of the engagement cavity 76 near the center of the array. The other end of the spline shaft 70 extends into the thread groove 23 and a device is splined thereon. 86. An end of the sealing cover 26 near the center of the array turns A fourth bevel gear 69 is provided. The center of the fourth bevel gear 69 is splined and is splined to the device 86. The opening and closing groove 24 is provided with a locking groove 68 near the thermostat 75. The device 86 can extend into the locking groove 68 to lock the sealing cover 26.

Beneficially, the inner end wall of the spline shaft 70 is thread-shaped, the outer periphery of the device 86 is composed of a spline structure and a threaded structure, and the outer periphery of the spline part of the device 86 is splined to the fourth bevel gear 69, The threaded part of the device 86 is threadedly connected to the thread groove 23, so that the rotation of the fourth bevel gear 69 drives the device 86 to rotate, the device 86 moves horizontally to lock or unlock the sealing cover 26, and The device 86 drives the spline shaft 70 to rotate, so that the sealing plate 82 can be raised and lowered to seal or open the storage cavity 17.

According to the embodiment, the cutting device 88 is described in detail below. The cutting device 88 includes a blocking groove 71 communicating with the flow chamber 72. The blocking plate 73 is slidably disposed in the blocking groove 71. The lower end surface of the blocking plate 73 is a toothed structure. A transmission cavity 59 is provided on the lower side of the blocking groove 71. A spur gear 62 meshing with the blocking plate 73 is rotatably provided in the transmission cavity 59. A fifth bevel gear 61 is fixed on an end of the spur gear 62 remote from the thermostat 75. A symmetrical connecting shaft 57 is provided in the transmission cavity 59. A driving bevel gear 63 is fixed on the connecting shaft 57. The transmission bevel gear 63 is composed of a bevel gear and a pulley fixed front and rear. A portion of the transmission bevel gear 63 on the side of the thermostat 75 is meshed with the fifth bevel gear 61 and is away from the thermostat. A sixth bevel gear 65 is meshed and connected with the bevel gear part of the transmission bevel gear 63 on the 75 side. The belt bevel parts of the left and right transmission bevel gears 63 are connected by a timing belt 60 at the center. A transmission shaft 66 is fixedly installed, and the transmission shaft 66 extends upward and is fixedly provided. The seventh bevel gear 67 meshed with the fourth bevel gear 69, so that when the transmission bevel gear 63 rotates, the blocking plate 73 is moved to control the closed state of the circulation cavity 72, and the seventh bevel The rotation of the gear 67 provides power for the operation of the sealing device 89.

Beneficially, a telescoping groove 47 is provided in the storage block 16 near the center of the array, and the telescoping groove 47 is slidably provided with a telescoping block 48 having a lower end surface having a tooth shape and a rear end having an inclined surface structure. A telescoping spring 49 is fixed between the block 48 and the telescoping groove 47. A rotary space 51 is provided on the lower side of the telescoping groove 47. A symmetrical rotary shaft 53 is rotatably arranged in the rotary space 51. The rotary shaft A rotating pulley 58 is fixed on 53. The rotating pulleys 58 are dynamically connected by a rotating belt 54. A rear end of the rotating pulley 58 near the center of the array is fixed with a meshing mesh with the telescopic block 48. The meshing gear 52 is connected to the rear end of the rotation shaft 53 on the side far from the center of the array and the rear end of the connection shaft 57 on the side close to the center of the array through a transmission belt 56 so that the telescopic block 48 moves horizontally. The driving belt 56 is driven to rotate at times, and then the connecting shaft 57 is rotated to provide power for the cutting device 88 to work.

Beneficially, a groove 50 is provided in the left end wall of the turning cavity 15 on the right side, and when the telescopic groove 47 is opposite to the groove 50, the telescopic block 48 can act on the elasticity of the telescopic spring 49 The force extends into the groove 50, and the telescopic block 48 moves horizontally.

According to an embodiment, an oscillating device 87 is described in detail below. The oscillating device 87 includes an oscillating cavity 11, the oscillating motor 12 is fixedly mounted on a lower end wall of the oscillating cavity 11, and an oscillating shaft is mounted on the upper end of the oscillating motor 12. 13. An oscillating plate 14 is fixed on the upper end of the oscillating shaft 13, and the oscillating plate 14 is fixedly connected to the five storage blocks 16 respectively, so that the oscillating motor 12 works and the storage is driven by the oscillating plate 14 Block 16 oscillates.

The following describes the steps of using a platelet storage tank in detail with reference to FIGS. 1 to 5:

Initially, except for the rightmost rotating cavity 15, the five storage blocks 16 are located in the remaining five rotating cavities 15, respectively. One end face of the moving block 31 away from the oscillation motor 12 abuts against the inner end wall of the moving groove 30, and the cover is sealed. 26 is set horizontally, the device 86 is inserted into the locking groove 68, the seventh bevel gear 67 meshes with the fourth bevel gear 69, the sealing plate 82 seals the storage cavity 17, the blocking plate 73 is contracted in the blocking groove 71, and the circulation cavity 72 communicates The thermostat 75 and the storage cavity 17, the telescopic block 48 are contracted in the telescopic groove 47, and the telescopic spring 49 is in a compressed state.

When placed, the driving motor 81 starts to drive the driving gear 85 to rotate, then the storage block 16 rotates, the storage block 16 to be placed in the test tube 22 is rotated into the right rotation chamber 15 and the driving motor 81 stops. At this time, the expansion groove 47 and the concave The grooves 50 are opposite to each other, the telescopic block 48 extends into the groove 50 under the elastic restoring force of the telescopic spring 49. The movement of the telescopic block 48 drives the meshing gear 52 to rotate, and the transmission through the rotation of the belt 54 and the transmission belt 56 makes the transmission The bevel gear 63 rotates, and the left transmission bevel gear 63 rotates to drive the spur gear 62 to rotate. The blocking plate 73 moves forward into the circulation cavity 72. The blocking plate 73 blocks the circulation cavity 72. The right transmission cone The rotation of the gear 63 drives the seventh bevel gear 67 to rotate, the fourth bevel gear 69 rotates, and the device 86 rotates, the device 86 moves to the right and disengages from the lock groove 68, the seal cover 26 is unlocked, and the spline shaft is driven when the device 86 rotates Turning 70, the connecting bevel gear 78 drives the threaded shaft 79 to rotate, so that the sealing plate 82 rises into the receiving groove 80 and exits the storage chamber 17, and then, the handle 83 is rotated clockwise to seal the cover 26 to open the storage chamber 17;

When the seal cover 26 is rotated, the rotation gear 28 is driven by the linkage belt 27, and the moving block 31 moves to the left, so that the third bevel gear 36 meshes with the conical ring gear 38, and the test tube 22 storing the new platelets passes through the fixing block 19 And the clamping block 20 is placed on the placing block 18, the power motor 40 is started to rotate the conical gear ring 38, and the third bevel gear 36 drives the second bevel gear 34 to rotate, so that the worm 45 drives the transmission gear 43 to rotate, Further, the clamping block 20 moves to the left, and the cooperation between the clamping block 20 and the fixing block 19 clamps the test tube 22 in the storage cavity 17;

Thereafter, when the sealing cover 26 is turned counterclockwise to a horizontal state, the moving block 31 is moved to the right through the linkage belt 27, the third bevel gear 36 is disengaged from the tapered ring gear 38, and the driving motor 81 is started to drive the driving gear 85 to rotate. When the storage block 16 rotates around the center of the array, the telescopic block 48 is squeezed by the inner end wall of the groove 50 and moved to the right into the telescopic groove 47. The telescopic spring 49 is compressed. When the telescopic block 48 moves, the meshing gear 52 is driven to reverse. Then, by rotating the belt 54 and the transmission belt 56 to make the transmission bevel gear 63 reverse, the blocking plate 73 moves into the blocking groove 71 to open the flow chamber 72. The right transmission bevel gear 63 rotates to drive the seventh bevel gear 67 Turning, the fourth bevel gear 69 rotates, causing the device 86 to move into the locking groove 68, the spline shaft 70 reverses, and the screw shaft 79 is reversed, and the sealing plate 82 is lowered into the storage cavity 17 to seal the storage cavity 17;

During storage, the heat produced by the thermostat 75 is transferred to the storage chamber 17 through the circulation chamber 72, so that the five storage chambers 17 are kept at a constant temperature state, the oscillation motor 12 is started, and the five storage blocks 16 are oscillated by the oscillation plate 14, and then the test tube 22 oscillates and is stored in a constant temperature environment.

The beneficial effect of the present invention is that the test tube in which the platelets are stored can be clamped in the storage cavity by the clamping device of the present invention, and the storage cavity is independent and communicates with the thermostat independently. The constant temperature conditions in the storage chamber are blocked, reducing the loss of energy, without destroying the constant temperature environment in other storage chambers, and extending the storage time of platelets. Secondly, the sealing device can keep the storage chamber in a sealed state, and during the oscillation process The sealing cover and the storage chamber are always locked to ensure constant temperature in the storage chamber.

In the above manner, those skilled in the art can make various changes according to the working mode within the scope of the present invention.

1. A platelet oscillating storage box includes a box body, which is characterized in that the box body is provided with six circular array and connected rotating cavities;
There are five storage blocks in the rotating cavity. The storage block is provided with a storage cavity. A lower end wall of the storage cavity is fixed with a placement block. An end of the storage cavity near the center of the array is fixed with a symmetrical upper and lower fixing block. A movable clamping block is provided between the fixed blocks, the clamping block and the center of the fixed block both penetrate up and down, and a buffer pad is fixed on the inner end wall thereof, and the test tube storing the platelets is placed in the The lower end of the test tube is placed between the fixing block and the clamping block, and the test tube is moved toward the center of the array to clamp the test tube, and the storage cavity is close to the center of the array. A clamping device is provided on the side, and the clamping device can drive the clamping block to move horizontally for clamping and releasing the test tube;
A sealing device is provided on the upper side of the storage cavity. The sealing device includes a rotatable sealing cover and a lifting sealing plate. When the sealing cover is horizontally arranged, the sealing plate extends into the storage cavity to seal it. A fixed plate is fixed between the upper end surfaces of the storage blocks, a thermostat is installed in the fixed plate, and a circulation cavity is provided between the storage cavity and the thermostat, so that the storage cavity is kept at a constant temperature. A cutting device is provided on the upper side of the circulation cavity. The cutting device includes a blocking plate that can be moved forward and backward, and the blocking plate can block the circulation of the circulation cavity. At this time, the cutting device can work as the The sealing device provides power for operation. An oscillating device is provided on the lower side of the thermostat. The oscillating device includes an oscillating motor. The five oscillating motors are connected to each of the storage blocks. Then, the oscillating motor works to drive the storage cavity to oscillate. The test tube oscillates to facilitate storage of platelets.

2. The platelet oscillating storage box according to claim 1, characterized in that the lower end surface of the storage block is a toothed structure, a driving groove is provided on the lower end wall of the rotating cavity, and a driving groove is provided in the driving groove. The driving gear meshed with the storage block, a driving motor is installed at the right end wall of the driving groove, and the driving gear is dynamically connected with the driving motor.

3. The platelet oscillating storage box according to claim 1, wherein the holding device comprises a through groove communicating with the storage cavity;
An end of the clamping block near the center of the array extends into the through groove, and a lower end surface of the clamping block is a toothed structure. A self-locking groove is provided on the lower side of the through groove, and the self-locking groove rotates. A transmission gear meshed with the clamping block is provided. A turbine is fixed on one end surface of the transmission gear, and a worm is meshed with the end of the turbine near the center of the array. A worm shaft is fixed at the center of the worm. A connection groove is provided on the lower side of the self-locking groove. A lower end of the worm shaft extends into the connection groove and a first bevel gear is fixed. A second bevel gear is meshed with the end of the first bevel gear away from the center of the array. A spline rod is splined at the center of the second bevel gear, and a third bevel gear is fixed at the left end of the spline rod;
A moving groove is provided on the right side of the connecting groove, and a moving block is slidably arranged in the moving groove. The right end of the spline rod is rotatably connected to the moving block, and the upper end surface of the moving block is tooth-shaped and meshingly connected. There is a rotating gear, and a gear rotating shaft is fixed at the center of the rotating gear.

4. The platelet storage tank according to claim 1, wherein: a ring-shaped cavity is provided in the box body;
A conical toothed ring is provided for rotation in the annular cavity, and the outer periphery of the conical toothed ring can be engaged with the third bevel gear. A power gear is engaged with the inner end wall of the conical toothed ring, and the upper end of the annular cavity is connected. A power motor is fixed on the wall, and the power gear is dynamically connected with the power motor.

5. The platelet oscillating storage box according to claim 1, wherein the sealing device comprises an opening and closing groove that communicates the upper side of the storage cavity with the outside;
The sealing cover is rotatably provided in the opening and closing groove through a flip cover shaft, the front end of the flip cover shaft and the gear rotating shaft are dynamically connected through a linkage belt, a handle is fixed on the upper end surface of the seal cover, A receiving slot with an opening facing downward is provided, and the sealing plate is slidably disposed in the receiving slot. An upper side of the receiving slot is provided with a meshing cavity. The meshing cavity is provided with a connection bevel gear through a screw shaft. The lower end of the threaded shaft extends into the receiving groove and is threadedly connected to the sealing plate. An end of the connecting bevel gear near the center of the array is meshed with a rotating bevel gear, and a spline shaft is fixed at the center of the rotating bevel gear.
A thread groove is provided on the side of the engagement cavity near the center of the array, the other end of the spline shaft extends into the thread groove, and a device is splined thereon. A fourth bevel gear, the center of the fourth bevel gear is splined and is splined to the device, the opening and closing groove is provided with a locking groove on the side of the thermostat, and the device can extend to the In the locking groove, the sealing cover is locked.

6. The platelet storage tank according to claim 5, wherein the inner end wall of the spline shaft is thread-shaped, the outer periphery of the device is composed of a spline structure and a thread structure, and the outer periphery of the spline part of the device It is splined to the fourth bevel gear, and the threaded part of the device is threadedly connected to the threaded groove.

7. The platelet oscillating storage box according to claim 1, wherein the cutting device comprises a blocking groove in communication with the circulation cavity;
The blocking plate is slidably disposed in the blocking groove, and the lower end surface of the blocking plate is a toothed structure. A transmission cavity is provided on the lower side of the blocking groove, and a rotation cavity is provided in the transmission cavity. A spur gear meshed with the blocking plate, a fifth bevel gear is fixed on an end of the spur gear far from the thermostat, a symmetrical connecting shaft is arranged in the transmission cavity, and a transmission is fixed on the connecting shaft. A bevel gear, the transmission bevel gear is composed of a bevel gear and a pulley fixed front and rear, the bevel gear portion of the transmission bevel gear close to the thermostat side is meshed with the fifth bevel gear, away from the thermostat A sixth bevel gear is meshed with the bevel gear part of the transmission bevel gear on the side, and the left and right transmission bevel gear pulley parts are dynamically connected through a timing belt. A transmission shaft is fixed at the center of the sixth bevel gear. A seventh bevel gear that extends in the axial direction and is fixedly engaged with the fourth bevel gear.

8. The platelet oscillating storage box according to claim 1, characterized in that: an expansion groove is provided on the side of the storage block near the center of the array;
A telescoping block having a toothed lower end surface and a beveled structure at the rear end is slidably provided in the telescoping slot. A telescoping spring is fixed between the telescoping block and the telescoping slot. There is a rotating space. A symmetrical rotating shaft is provided for rotation in the rotating space. A rotating pulley is fixed on the rotating shaft. The rotating pulleys are connected by a rotating belt power. A meshing gear meshing with the telescopic block is fixed at the rear end of the rotating pulley, and a transmission belt passes between the rear end of the rotating shaft on the side far from the center of the array and the rear end of the connecting shaft on the side close to the center of the array. Power connection.

9. The platelet storage tank according to claim 1, wherein a groove is provided in a left end wall of the rotating cavity on the right side.

10. The platelet storage tank according to claim 1, wherein the oscillating device comprises an oscillating cavity;
The oscillating motor is fixed on the lower end wall of the oscillating cavity. An oscillating shaft is installed on the upper end of the oscillating motor. An oscillating plate is fixed on the upper end of the oscillating shaft. The oscillating plate is fixedly connected to the five storage blocks.
